(19) United States
(12) Patent Application Publication
(10) Pub. No.: US 2026/0086319 A1
(43) Pub. Date: Mar. 26, 2026

(54) OPTICAL SYSTEM, AND CAMERA DEVICE INCLUDING SAME

(71) Applicant: LG INNOTEK CO., LTD., Seoul (KR)

(72) Inventor: Ju Yong SHIM, Seoul (KR)

(21) Appl. No.: 19/109,659

(22) PCT Filed: Sep. 8, 2023
(86) PCT No.: PCT/KR2023/013519

§ 371 Date: Mar. 7, 2025

(30) Foreign Application Priority Data
Sep. 8, 2022 (KR) 10-2022-0114296

(51) Int. Cl. G02B 9/60

(52) U.S. Cl. CPC G02B 9/60

(57) ABSTRACT

An optical system according to an embodiment of the present invention includes an aperture, a first lens, a second lens, a third lens, a fourth lens, and a fifth lens which are sequentially arranged from an object side to an image side, wherein the first lens has positive refractive power, the second lens has negative refractive power, the third lens has positive refractive power, the fourth lens has positive refractive power, and the fifth lens has negative refractive power. Both the object-side and image-side surfaces of the fifth lens have an asymmetric circular shape.

### TECHNICAL FIELD

Embodiments of the present invention relate to an optical system and a camera device including the same.

### BACKGROUND ART

As the performance of a camera device built in a mobile terminal progresses, the demand for higher resolution in the camera device in the mobile terminal is also increasing. In order to improve the performance of the camera device, the high performance of an optical system and an image sensor is required. However, due to a narrow space in the mobile terminal, the high-performance of the optical system and the image sensor is not easy.

Specifically, the need for miniaturization of the camera device is further increasing. As the camera device becomes smaller, an amount of light which reaches the image sensor through the optical system may decrease. Accordingly, an F-number which determines the brightness of an image may increase, and an amount of light which reaches a peripheral region of the image sensor may decrease compared an amount of light which reaches a central region of the image sensor.

### DISCLOSURE

### Technical Problem

The technical problem to be achieved by the present invention is to acquire a camera module with a small F-number, a large field of view, and a high relative illumination while being implemented in a small size.

The problem to be solved in the embodiment is not limited to this, and it can be said that the purpose or effect that can be understood from the specific contents for implementing the solution or invention of the problem described below is also included.

### Technical Solution

An optical system according to one embodiment of the present invention includes an aperture, a first lens, a second lens, a third lens, a fourth lens, and a fifth lens, which are sequentially disposed from an object side to an image side, wherein the first lens has positive refractive power, the second lens has negative refractive power, the third lens has positive refractive power, the fourth lens has positive refractive power, and the fifth lens has negative refractive power, and both an object-side surface and an image-side surface of the fifth lens have a circular asymmetric shape.

An entrance pupil diameter (EPD) may be greater than or equal to an effective diameter of an object-side surface of the first lens.

When the aperture is closed, the shortest distance between the aperture and the object-side surface of the first lens may be 0.2 mm or less.

A distance between an image-side surface of the first lens and an object-side surface of the second lens and a distance between an image-side surface of the second lens and an object-side surface of the third lens may each be shorter than a distance between an image-side surface of the third lens and an object-side surface of the fourth lens, and a maximum effective diameter among an object-side surface and the image-side surface of the first lens, the object-side surface and the image-side surface of the second lens, and the object-side surface and the image-side surface of the third lens may be smaller than a minimum effective diameter among the object-side surface and an image-side surface of the fourth lens and the object-side surface and the image-side surface of the fifth lens.

The maximum effective diameter of the object-side surface and the image-side surface of the first lens, the object-side surface and the image-side surface of the second lens, and the object-side surface and the image-side surface of the third lens may be 0.7 times or less an effective diameter of the image-side surface of the fifth lens.

The first lens, the second lens, the third lens, and the fourth lens may be circular symmetrical lenses.

At least one surface of the object-side surface and the image-side surface of the first lens, the object-side surface and the image-side surface of the second lens, and the object-side surface and the image-side surface of the third lens may include a critical point whose tilt angle is 0.

At least two surfaces of the object-side surface of the fourth lens, the image-side surface of the fourth lens, and the object-side surface of the fifth lens may not include the critical point, the object-side surface of the fourth lens may be concave toward the object side, the image-side surface of the fourth lens may be convex toward the image side, and the object-side surface of the fifth lens may be concave toward the object side.

An absolute value of a radius of curvature of the image-side surface of the fourth lens may be 0.9 to 1.1 times an absolute value of a radius of curvature of the object-side surface of the fifth lens.

A sag value in a first direction and a sag value in a second direction perpendicular to the first direction of the object-side surface of the fifth lens may be different from each other for the same distance from an optical axis, and a sag value in the first direction and a sag value in the second direction of the image-side surface of the fifth lens may be different from each other for the same distance from the optical axis.

The sag value in the first direction or the sag value in the second direction of the object-side surface of the fifth lens may be different from a sag value in a third direction between the first direction and the second direction for the same distance from the optical axis.

A deviation between the sag value in the first direction or the sag value in the second direction and the sag value in the third direction of the object-side surface of the fifth lens may be greater than a deviation between the sag value in the first direction and the sag value in the second direction of the object-side surface of the fifth lens for the same distance from the optical axis

A deviation between the sag value in the first direction and the sag value in the second direction of the image-side surface of the fifth lens may be greater than a deviation between the sag value in the first direction and the sag value in the second direction of the object-side surface of the fifth lens for the same distance from the optical axis.

A deviation between a maximum sag value in the first direction and a maximum sag value in the second direction of the image-side surface of the fifth lens may be 10 times or more a deviation between the maximum sag value in the first direction and the maximum sag value in the second direction of the object-side surface of the fifth lens.

The image-side surface of the fifth lens may include a critical point whose tilt angle is 0.

A maximum tilt angle from the critical point of the image-side surface of the fifth lens to an edge of the image-side surface of the fifth lens may be 5 to 7 times a maximum tilt angle from the optical axis to the critical point of the image-side surface of the fifth lens.

A maximum tilt angle may be 65 degrees or less within a range of 60 to 90% of the effective diameter of the image-side surface of the fifth lens.

An F-number may be 2.45 or less, a field of view (FOV) may be 80 degrees or more, and a relative illumination (RI) may be 40% or more.

A camera device according to one embodiment of the present invention includes an image sensor, a filter disposed on the image sensor, and an optical system disposed on the filter, wherein the optical system includes an aperture, a first lens, a second lens, a third lens, a fourth lens, and a fifth lens, which are sequentially disposed from an object side to an image side, wherein the first lens has positive refractive power, the second lens has negative refractive power, the third lens has positive refractive power, the fourth lens has positive refractive power, and the fifth lens has negative refractive power, and both an object-side surface and an image-side surface of the fifth lens have a circular asymmetric shape.

### Advantageous Effects

According to the embodiment of the present invention, a camera device with a small F-number, a large field of view (FOV), and a high relative illumination (RI) while being implemented in a small size can be acquired.

According to the embodiment of the present invention, a camera device with an F-number of 2.45 or less, an FOV of 80 degrees or more, and an RI in 1 field of 40% or more while being implemented in a small size can be acquired.

According to the embodiment of the present invention, a camera device providing an image with a high RI while minimizing a head size exposed to the outside can be acquired. That is, in order to minimize the head size exposed to the outside, a camera device providing an image with a high RI around a sensor while designing a diameter of a first lens, that is, a lens disposed closest to an object side, to be small can be acquired.

### DESCRIPTION OF DRAWINGS

FIG. 1 shows an optical system according to an embodiment of the present invention.

FIG. 2 shows a relationship between a first lens and an aperture of the optical system according to the embodiment of the present invention.

FIGS. 3 and 4 are views for describing a relative illumination.

FIG. 5 is design data showing distances between lens surfaces according to a distance in a Y direction from an optical axis in the optical system according to the embodiment of the present invention.

FIG. 6 is design data showing sag values of lens surfaces according to a distance in the Y direction from the optical axis on the first to fourth lenses of the optical system according to the embodiment of the present invention.

FIG. 7 is design data showing the sag values of lens surfaces according to a distance in the X direction, the Y direction, a diagonal direction, and a 45 degrees direction from the optical axis on a fifth lens of the optical system according to the embodiment of the present invention.

FIG. 8 is design data showing tilt angles of lens surfaces according to a distance in the Y direction from the optical axis in the optical system according to the embodiment of the present invention.

FIG. 9 shows a modulation transfer function (MTF) using an optical system according to one embodiment of the present invention.

FIG. 10 shows a distortion grid using the optical system according to one embodiment of the present invention.

FIG. 11 is a view showing a portion of a mobile terminal to which a camera device according to one embodiment of the present invention is applied.

### MODES OF THE INVENTION

Hereinafter, exemplary embodiments according to the present invention will be described in detail with reference to the accompanying drawings.

However, the technical spirit of the present invention is not limited to some embodiments to be described, but may be implemented in various different forms, and one or more of the components between the embodiments may be selectively combined and substituted within the technical spirit of the present invention.

Further, terms (including technical and scientific terms) used in the embodiments of the present invention may be interpreted as meanings which may be generally understood by those skilled in the art unless explicitly specifically defined and described, and the meanings of the generally used terms such as terms defined in a dictionary may be understood in consideration of contextual meanings in the related art.

In addition, the terms used in the embodiments of the present invention are provided not to limit the present invention but to describe the embodiments.

In the present specification, a singular form may also include a plural form unless otherwise specified in the phrase, and may include one or more of all possible combinations of A, B, and C when disclosed as at least one (or one or more) of “A, B, and C”.

Further, terms such as first, second, A, B, (a), (b), and the like may be used to describe the components of the embodiment of the present invention.

These terms are only provided to distinguish one component from another component, and the essence, sequence, order, or the like of the elements are not limited by these terms.

Further, when a specific component is disclosed as being “connected,” “coupled,” or “linked” to another component, this may not only include a case of the component being directly connected, coupled, or linked to the other component but also a case of the component being connected, coupled, or linked to the other component by another component between the element and the other component.

In addition, when one component is disclosed as being formed “on or under” another component, the term “on or under” includes both a case in which the two components are in direct contact with each other and a case in which at least another component is disposed between the two components (indirectly). In addition, when the term “on or under” is expressed, a meaning of not only an upward direction but also a downward direction may be included based on one component.

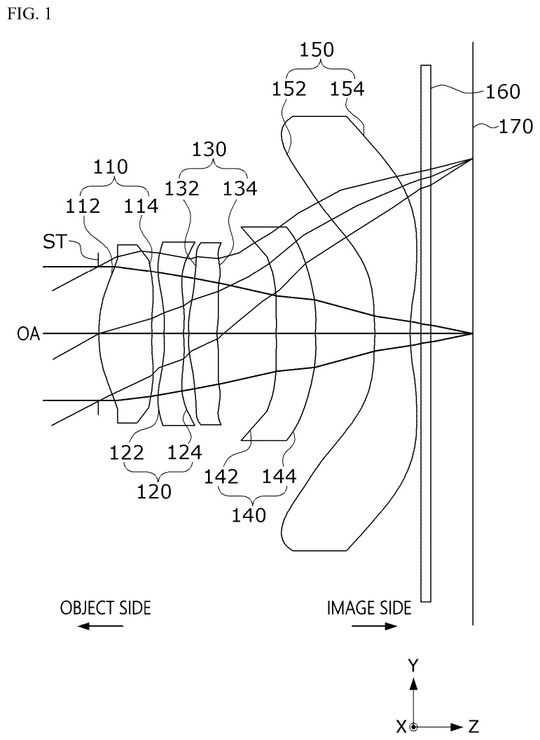

FIG. 1 shows an optical system according to an embodiment of the present invention.

Referring to FIG. 1, an optical system 100 according to the embodiment of the present invention includes a first lens 110, a second lens 120, a third lens 130, a fourth lens 140, and a fifth lens 150, which are sequentially disposed from an object side to an image side.

Although not shown, a right-angled prism may be further disposed in front of the first lens 110.

At least one of the first lens 110, the second lens 120, the third lens 130, the fourth lens 140, and the fifth lens 150 may include an effective region and an ineffective region. The effective region may be a region through which light incident on the lens passes, that is, a region through which the incident light is refracted to implement optical characteristics. In the present specification, an effective diameter may mean a diameter of the effective region through which effective light is incident on each surface of each lens. In the present specification, a numerical value of the effective diameter may have a certain error range. For example, a range of ±0.4 mm may be considered as the effective region for the numerical value of the effective diameter presented in the present specification, and the range of ±0.4 mm may be interpreted as the effective diameter for the numerical value of the effective diameter presented in the present specification. The non-effective region is disposed at a perimeter of the effective region and may be a region where light is not incident, that is, a region unrelated to the optical characteristics. The non-effective region may be a region fixed to a barrel which accommodates a lens, or the like.

According to the embodiment of the present invention, a filter 160 and an image sensor 170 may be sequentially disposed behind the fifth lens 150. In this case, the filter 160 may be an infrared (IR) filter. Accordingly, the filter 160 may block near-infrared rays, for example, light with a wavelength of 700 nm to 1100 nm, from light incident on a camera device. Alternatively, the filter 160 may be a filter which transmits IR rather than a filter which blocks IR. Further, the image sensor 170 may be connected to a printed circuit board.

According to the embodiment of the present invention, the first lens 110, the second lens 120, the third lens 130, the fourth lens 140, and the fifth lens 150 may be sequentially disposed along the optical axis. According to the embodiment of the present invention, the first lens 110, the second lens 120, the third lens 130, and the fourth lens 140 may be circular symmetrical lenses, and the fifth lens 150 may be a circular asymmetrical lens. The first lens 110, the second lens 120, the third lens 130, the fourth lens 140, and the fifth lens 150 may each be made of plastic or glass.

The first lens 110 has positive refractive power and includes an object-side surface 112 and an image-side surface 114, and the object-side surface 112 of the first lens 110 may be convex toward the object side and the image-side surface 114 may be concave toward the image side. Here, a case in which the surface of the lens is convex may mean that the surface of the lens in the region corresponding to the optical axis has a convex shape, and a case in which the surface of the lens is concave may mean that the surface of the lens in the region corresponding to the optical axis has a concave shape. Here, the region corresponding to the optical axis may mean an optical axis region or a paraxial region. Furthermore, the case in which the surface of the lens is convex toward the object side may mean that the surface of the lens is concave toward the image side, and the case in which the surface of the lens is convex toward the image side may mean that the surface of the lens is concave toward the object side.

The second lens 120 has negative refractive power and includes an object-side surface 122 and an image-side surface 124, and the object-side surface 122 of the second lens 120 may be concave toward the object side and the image-side surface 124 may be convex toward the image side.

The third lens 130 has positive refractive power and includes an object-side surface 132 and an image-side surface 134, and the object-side surface 132 of the third lens 130 may be convex toward the object side and the image-side surface 134 may be concave toward the image side.

The fourth lens 140 has positive refractive power and includes an object-side surface 142 and an image-side surface 144, and the object-side surface 142 of the fourth lens 140 may be concave toward the object side and the image-side surface 144 may be convex toward the image side.

The fifth lens 150 may have negative refractive power and include an object-side surface 152 and an image-side surface 154, and the object-side surface 152 of the fifth lens 150 is concave toward the object side and the image-side surface154 is concave toward the image side.

In the embodiment of the present invention, when the first lens 110 has positive refractive power, the second lens 120 has negative refractive power, the third lens 130 has positive refractive power, the fourth lens 140 has positive refractive power, and the fifth lens 150 has negative refractive power, chromatic aberration may be corrected.

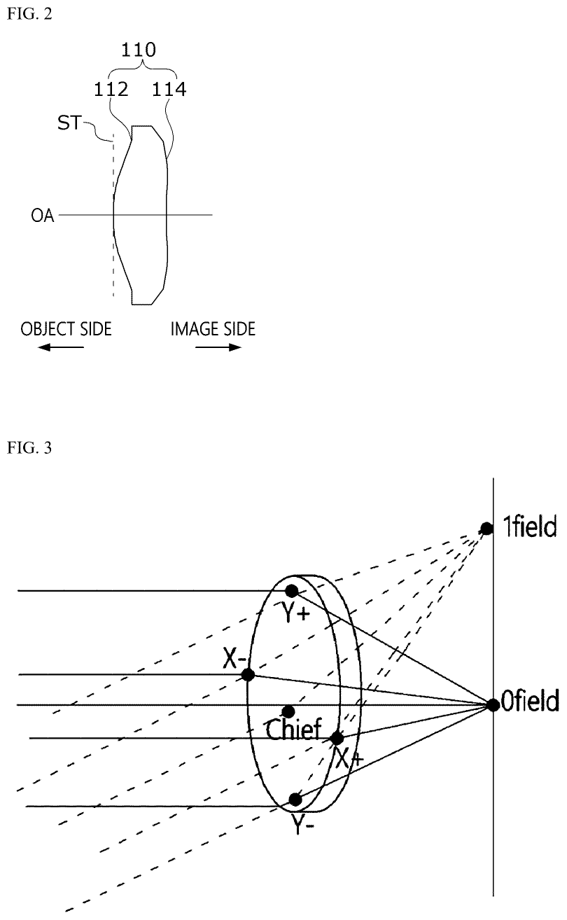

FIG. 2 shows a relationship between a first lens and an aperture in the optical system according to the embodiment of the present invention.

Referring to FIG. 2, an aperture ST is disposed closer to the object side than the first lens 110. The aperture ST may adjust an amount of light incident on the optical system 100. Accordingly, the optical system 100 according to the embodiment of the present invention includes the aperture ST, the first lens 110, the second lens 120, the third lens 130, the fourth lens 140, and the fifth lens 150, which are sequentially disposed from an object side to an image side. According to the embodiment of the present invention, the aperture ST is disposed closer to the object side than the object-side surface 112 of the first lens 110. In a state in which the aperture ST is closed, the aperture ST may be disposed on the front of a region corresponding to the optical axis of the object-side surface 112 of the first lens 110. For example, in a state in which the aperture ST is closed, the aperture ST may be disposed on the front of a region corresponding to an optical axis OA of the object-side surface 112 of the first lens 110 at a distance of 0.2 mm or less, preferably 0.1 mm or less, more preferably 0.05 mm or less, and more preferably 0.01 mm or less from the region corresponding to the optical axis OA of the object-side surface 112 of the first lens 110. In a case in which the aperture ST is not a drivable aperture, the shortest distance between a position where the aperture is disposed and the object-side surface 112 of the first lens 110 may be 0.2 mm or less.

According to the embodiment of the present invention, an entrance pupil diameter (EPD) of the optical system 100 may be greater than or equal to an effective diameter (ED_{L1S1}) of the object-side surface 112 of the first lens 110. The EPD of the optical system 100 may be 1 to 1.3 times, preferably 1.1 to 1.25 times, and more preferably 1.15 to 1.25 times the effective diameter (ED_{L1S1}) of the object-side surface 112 of the first lens 110. Accordingly, since an area of the object-side surface112 of the first lens 110 exposed to the outside may be minimized, a head size of the optical system 100 may be minimized.

Referring to FIG. 1 again, the object-side surface 112 of the first lens 110 has the smallest effective diameter among the first to fifth lenses 110, . . . , and 150. For example, the effective diameter (ED_{L1S1}) of the first lens 110 may be 1.16 mm to 1.96 mm. According to the embodiment of the present invention, the effective diameter of the object-side surface 112 of the first lens 110 may be smaller than a length in a diagonal direction of the image sensor 170. For example, the effective diameter of the object-side surface 112 of the first lens 110 may be 70% or less, preferably 50% or less, more preferably 40% or less, and more preferably 30% or less of the length in the diagonal direction of the image sensor 170. When the effective diameter (ED_{L1S1}) of the first lens 110 and the length in the diagonal direction of the image sensor 170 satisfy this, design for minimizing a head size of the optical system exposed to the outside may be performed. When the aperture ST is disposed on the front of the object-side surface 112 of the first lens 110, since the amount of light incident on the first lens 110 may be maximized while minimizing the area of the optical system 100 exposed to the outside, the optical system 100 may be implemented in a compact size. For example, a camera device including the optical system 100 according to the embodiment of the present invention may be implemented so as not to be exposed to the user's naked eye. For example, the camera device including the optical system 100 according to the embodiment of the present invention may be implemented to be disposed on the front of a mobile terminal. For example, the camera device including the optical system 100 according to the embodiment of the present invention may be implemented to be disposed under a display.

Meanwhile, as the effective diameter of the first lens 110 becomes smaller, the head size exposed to the outside may be minimized. However, as the effective diameter of the first lens 110 becomes smaller, the amount of light incident on the optical system 100 may be insufficient. Accordingly, when the optical system including the first lens 110 is designed, it is necessary to consider conditions for brightening the image by reducing an F number and improving a ratio of an amount of light incident on the periphery of the image sensor to an amount of light incident on a central portion of the image sensor, that is, a relative illumination (RI).

Here, the central portion of the image sensor means a region close to a 0 field of the image sensor, and the periphery of the image sensor means a region close to a 1 field of the image sensor.

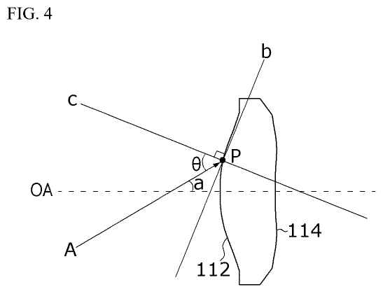

FIGS. 3 and 4 are views for describing the relative illumination.

Referring to FIG. 3, it can be seen that a region that reaches the image sensor depends on an incident angle of light incident from the object side. That is, the image sensor is divided into a 0 field region which is the central portion of the image sensor, and a 1 field region which is the farthest location from the central portion of the image sensor, and it can be seen that light reaches closer to the 1 field region (the periphery) of the image sensor as the incident angle of the light is larger, and the light reaches closer to the 0 field region (the center) as the incident angle of the light is smaller.

Referring to FIG. 4, it is assumed that a first ray A is a ray parallel to a field of view (FOV) of the optical system 100. The first ray A may be incident on the object-side surface 112 of the first lens 110 to have an angle of a with respect to an optical axis OA of the first lens 110. In this case, an angle formed by the first ray A and a normal line (line c) at a point P where the first ray A and the object-side surface 112 of the first lens 110 contact each other may be defined as an incident angle θ.

According to the embodiment of the present invention, the lenses forming the optical system 100 are designed to reduce the F-number and improve the RI.

Tables 1 and 2 below show the optical characteristics of the lenses included in the optical system according to the embodiment of the present invention, Table 3 shows the Qcon coefficients of the first to fourth lenses included in the optical system according to the embodiment of the present invention, and Table 4 shows the Zernike coefficient of the fifth lens included in the optical system according to the embodiment of the present invention.

TABLE 1

| | Lens | | | Radius of | | | Effective |
|---|---|---|---|---|---|---|---|
| Lens | Surface | | Critical | Curvature | Curvature | Thickness | Diameter |
| Number | Number | Shape | Point | (R, mm) | (C, mm) | (mm) | (mm) |
| Aperture | ST | | | | | 0.000 | 1.560 |
| First | 112 | Convex | Not Present | 1.552 | 0.6442 | 0.614 | 1.872 |
| Lens | 114 | Concave | Present | 7.917 | 0.1263 | 0.147 | 2.084 |
| Second | 122 | Concave | Present | −2.025 | −0.4939 | 0.230 | 2.139 |
| Lens | 124 | Convex | Present | −4.239 | −0.2359 | 0.050 | 2.083 |
| Third | 132 | Convex | Not Present | 1.780 | 0.5619 | 0.333 | 2.135 |
| Lens | 134 | Concave | Present | 3.478 | 0.2876 | 0.692 | 2.122 |
| Fourth | 142 | Concave | Not Present | −7.644 | −0.1308 | 0.462 | 2.387 |
| Lens | 144 | Convex | Not Present | −2.701 | −0.3703 | 0.280 | 3.180 |
| Fifth | 152 | Concave | Not Present | −2.853 | −0.3505 | 0.510 | 4.182 |
| Lens | 154 | Concave | Present | 0.686 | 1.4573 | 0.433 | 5.058 |
| Filter | 162 | | | | | 0.110 | |
| | 164 | | | | | 0.490 | |
| Sensor | 170 | | | | | | |

TABLE 2

| | Lens | Focal | | | | Center | | Edge |
|---|---|---|---|---|---|---|---|---|
| Lens | Surface | Length | | Abbe | Refractive | Thickness | Air | Thickness |
| Number | Number | (f, mm) | Power | Number | Index | (mm) | Gap (mm) | (mm) |
| First | 112 | 3.4777 | 0.29 | 55.7074 | 1.5371 | 0.6141 | 0.1475 | 0.2300 |
| Lens | 114 | | | | | | | |
| Second | 122 | −5.8686 | −0.17 | 18.1193 | 1.6898 | 0.2300 | 0.0500 | 0.3678 |
| Lens | 124 | | | | | | | |
| Third | 132 | 6.3510 | 0.16 | 55.7074 | 1.5371 | 0.3327 | 0.6916 | 0.2363 |
| Lens | 134 | | | | | | | |
| Fourth | 142 | 7.0790 | 0.14 | 37.5647 | 1.5706 | 0.4616 | 0.6860 | 0.3621 |
| Lens | 144 | | | | | | | |
| Fifth | 152 | −2.6399 | −0.38 | 55.7074 | 1.5371 | 0.4078 | | 0.4683 |
| Lens | 154 | | | | | | | |
| Filter | 162 | | | | | | | |
| | 164 | | | | | | | |
| Sensor | 170 | | | | | | | |

TABLE 3

| | First Lens | | Second Lens | | Third Lens | | Fourth Lens | |
|---|---|---|---|---|---|---|---|---|
| Lens Surface Number | 112 | 114 | 122 | 124 | 132 | 134 | 142 | 144 |
| Y axis Radius | 1.552 | 7.917 | −2.025 | −4.239 | 1.780 | 3.478 | −7.644 | −2.701 |
| Normalization radius | 0.930 | 1.044 | 1.069 | 1.030 | 1.050 | 1.060 | 1.145 | 1.554 |
| Conic Constant | −0.105 | −79.951 | −41.146 | −95.018 | −24.141 | −62.051 | −68.654 | 1.732 |
| 4th order | −7.11E−02 | −1.92E−01 | 9.01E−02 | 1.66E−01 | −5.13E−02 | −7.42E−02 | −2.44E−01 | 6.98E−02 |
| 6th order | −1.50E−02 | −2.58E−02 | 2.56E−02 | 2.69E−02 | 1.94E−02 | 1.00E−02 | −5.51E−02 | 3.43E−02 |
| 8th order | −4.79E−03 | −6.45E−03 | −9.20E−03 | −7.02E−03 | 1.37E−02 | 1.51E−02 | −9.85E−03 | 3.58E−02 |
| 10th order | −8.37E−04 | −3.42E−03 | −2.19E−04 | −1.84E−03 | 1.93E−03 | 5.95E−03 | −1.17E−03 | 2.05E−03 |
| 12th order | −5.08E−04 | 7.28E−04 | 1.10E−03 | −1.22E−03 | −1.86E−03 | 1.93E−03 | 1.78E−03 | −2.28E−03 |
| 14th order | 1.02E−04 | 2.72E−04 | 4.53E−04 | 3.90E−04 | −8.73E−04 | 1.80E−04 | 8.22E−04 | −2.95E−03 |
| 16th order | −5.50E−05 | −4.34E−04 | −6.95E−04 | −6.04E−05 | −1.14E−04 | −1.04E−04 | 3.76E−04 | 9.87E−04 |
| 18th order | 9.73E−05 | −8.11E−05 | 1.64E−05 | 3.01E−05 | 1.68E−04 | −1.58E−04 | 2.44E−06 | 8.73E−04 |
| 20th order | −1.87E−05 | 9.40E−05 | 7.92E−05 | −3.12E−05 | 5.75E−05 | −1.12E−04 | −1.10E−04 | 4.56E−04 |
| 22th order | 4.31E−05 | 2.84E−05 | 7.57E−06 | 3.54E−06 | −1.89E−06 | −6.83E−05 | −7.44E−05 | −1.22E−04 |
| 24th order | −1.46E−05 | −6.46E−06 | −1.10E−05 | −8.07E−06 | −2.34E−05 | −3.68E−05 | −3.58E−05 | −1.39E−04 |
| 26th order | 2.04E−05 | 3.32E−06 | 8.69E−06 | 9.84E−07 | −8.04E−06 | −9.18E−06 | −6.80E−06 | −5.40E−05 |
| 28th order | −4.90E−06 | 3.04E−06 | −1.66E−06 | −1.68E−06 | −1.89E−06 | −2.71E−06 | 1.89E−06 | 4.12E−05 |
| 30th order | −5.31E−08 | 5.49E−06 | −2.94E−06 | 1.29E−06 | −8.96E−07 | 6.26E−06 | 1.26E−05 | 2.18E−05 |

TABLE 4

Fifth Lens

| | | |
|---|---|---|
| Lens Surface Number | 152 | 144 |
| Y axis Radius | −2.853 | 0.686 |
| Normalization radius | 2.036 | 2.520 |
| Conic Constant | −0.408 | −2.045 |
| 1st order | 2.63E−01 | −1.04E+00 |
| 4th order | 1.84E−02 | 2.26E−04 |
| 5th order | −1.19E−01 | −1.35E+00 |
| 11th order | −3.06E−02 | −3.49E−02 |
| 12th order | 5.21E−03 | −2.63E−02 |
| 13th order | 9.36E−02 | −5.52E−02 |
| 22nd order | −1.55E−02 | −7.26E−02 |
| 23rd order | −6.18E−03 | −3.31E−03 |
| 24th order | −1.75E−03 | −3.90E−02 |
| 25th order | 3.70E−02 | −5.88E−02 |
| 37th order | 5.69E−03 | 2.64E−02 |
| 38th order | −1.63E−04 | −3.20E−02 |
| 39th order | 2.50E−03 | 6.25E−03 |
| 40th order | −9.58E−05 | −2.18E−02 |
| 41st order | −2.61E−02 | −1.14E−02 |
| 57th order | −9.64E−04 | 4.62E−03 |
| 58th order | 2.50E−03 | −4.71E−03 |
| 59th order | 1.32E−03 | 5.94E−04 |
| 60th order | 1.02E−03 | −3.11E−03 |
| 61st order | 6.04E−03 | −5.66E−03 |

In Table 1, the thickness (mm) represents a distance from each lens surface to the next lens surface. For example, the thickness disclosed for the aperture ST represents a distance from the aperture ST to the object-side surface 112 of the first lens 110. Here, when the aperture ST is a drivable aperture, the distance from the aperture ST to the object-side surface 112 of the first lens 110 may mean the distance from the aperture ST to the object-side surface 112 of the first lens 110 in a state in which the aperture ST is closed. The thickness disclosed for the object-side surface 112 of the first lens 110 represents a distance from the object-side surface 112 to the image-side surface 114 of the first lens 110. In Table 1, the thickness (mm) may mean a distance from the optical axis. For example, the thickness disclosed for the object-side surface 112 of the first lens 110 may represent a distance between a center of curvature of the object-side surface 112 and a center of curvature of the image-side surface 114 of the first lens 110. The thickness disclosed for the image-side surface 114 of the first lens 110 represents a distance from the image-side surface 114 of the first lens 110 to the object-side surface 122 of the second lens 120. Specifically, the thickness disclosed for the image-side surface 114 of the first lens 110 represents a distance between a center of curvature of the image-side surface 114 of the first lens 110 and a center of curvature of the object-side surface 122 of the second lens 120.

In Tables 1 and 2, a center thickness CT may mean a thickness on the optical axis of each lens. For example, a center thickness of the first lens 110 may represent the distance between the center of curvature of the object-side surface 112 and the center of curvature of the image-side surface 114 in the first lens 110. An air gap may mean a distance between neighboring lenses on the optical axis. For example, an air gap of the first lens 110 may represent a distance between the center of curvature of the image-side surface 114 of the first lens 110 and the center of curvature of the object-side surface 122 of the second lens 120.

The thicknesses disclosed for the object-side surfaces of the first to fourth lenses which are circular symmetrical lenses in Table 1 may coincide with the center thicknesses of the first to fourth lenses in Table 2, and the thicknesses disclosed for the image-side surface of the first to third lenses which are circular symmetric lenses in Table 1 may coincide with the air gaps of the first to third lenses in Table 2. However, since the object-side surface 152 and the image-side surface 154 of the fifth lens 150 have a circular asymmetrical shape, there may be an offset. Accordingly, the thickness for the image-side surface 144 of the fourth lens 140 disclosed in Table 1, that is, a distance between the image-side surface 144 of the fourth lens 140 and the object-side surface 152 of the fifth lens 150 may not coincide with the air gap of the fourth lens 140 disclosed in Table 2. Similarly, the thicknesses for the object-side surface 152 of the fifth lens 150 disclosed in Table 1 may not coincide with the center thickness of the fifth lens 150 disclosed in Table 2.

In the optical system 100 according to the embodiment of the present invention, the first lens 110, the second lens 120, and the third lens 130 may be referred to as a first lens group G1, and the fourth lens 140 and the fifth lens 150 may be referred to as a second lens group G2.

According to the embodiment of the present invention, the first lens 110 may have the largest center thickness among the first to fifth lenses. According to the embodiment of the present invention, the sum of a center thickness CT2 of the second lens 120 and a center thickness CT3 of the third lens 130 may be smaller than the sum of a center thickness CT1 of the first lens 110. According to the embodiment of the present invention, the center thickness CT1 of the first lens 110 may be greater than a center thickness CT4 of the fourth lens 140, and may be greater than a center thickness CT5 of the fifth lens 150.

A distance between the first lens group G1 and the second lens group G2 of the present invention, that is, a distance T34 between the image-side surface 134 of the third lens 130 and the object-side surface 142 of the fourth lens 140 may be greater than a distance between neighboring lenses in the first lens group G1, for example, a distance T12 between the image-side surface 114 of the first lens 110 and the object-side surface 122 of the second lens 120 or a distance T23 between the image-side surface 124 of the second lens 120 and the object-side surface 132 of the third lens 130. The distance T34 between the first lens group G1 and the second lens group G2 of the present invention, that is, the distance T34 between the image-side surface 134 of the third lens 130 and the object-side surface 142 of the fourth lens 140 may be greater than or equal to a distance T45 between the image-side surface 144 of the fourth lens 140 and the object-side surface 152 of the fifth lens 150. Alternatively, the distance T34 between the first lens group G1 and the second lens group G2 of the present invention, that is, the distance T34 between the image-side surface 134 of the third lens 130 and the object-side surface 142 of the fourth lens 140 may be 0.95 to 1.1 times, preferably 0.97 to 1.05 times, and more preferably 0.99 to 1.02 times the distance T45 between the image-side surface 144 of the fourth lens 140 and the object-side surface 152 of the fifth lens 150. Further, the distance T12 between the image-side surface 114 of the first lens 110 and the object-side surface 122 of the second lens 120 and the distance T23 between the image-side surface 124 of the second lens 120 and the object-side surface 132 of the third lens 130 may be smaller than the distance T45 between the image-side surface 144 of the fourth lens 140 and the object-side surface 152 of the fifth lens 150.

When at least one of the power of the first to fifth lens, a shape of a lens surface, the center thickness of the lens, and the distance between the lenses satisfies the above condition, the first lens group G1 may serve to collect light and correct chromatic aberration, and the second lens group G2 may serve to uniformly spread light to each peripheral pixel of the image sensor. That is, according to the embodiment of the present invention, in order to reduce the head size of the optical system 100, the effective diameter of the object-side surface 112 of the first lens 110 is designed to be smaller than the image sensor 170. Precisely, the effective diameter of the object-side surface112 of the first lens 110 is designed to be smaller than the image sensor 170, and when the distances between the lenses in the first lens group G1 satisfy the above conditions, light may be collected without distortion even when the effective diameter of the object-side surface 112 of the first lens 110 is sufficiently small. Further, when the distances between the first lens group G and the second lens group G2 and the distances between the lenses in the second lens group G2 satisfy the above conditions, that is, when disposed farther than the distances between the lenses in the first lens group G1, the light collected by the first lens group G1 may pass through the second lens group G2 and uniformly reach each pixel of the image sensor 170 without distortion.

According to the embodiment of the present invention, the first lens 110, the second lens 120, and the third lens 130 have positive composite power, and the fourth lens 140 and the fifth lens 150 have negative composite power. That is, the composite power of the first lens 110, the second lens 120, and the third lens 130 may be 0.27, and the composite power of the fourth lens 140 and the fifth lens 150 may be −0.2. Accordingly, the first lens 110, the second lens 120, and the third lens 130 may serve to collect light incident on the object-side surface of the first lens 110, and the fourth lens 140 and the fifth lens 150 may serve to spread the light from the object-side surface 142 of the fourth lens 140 to the image-side surface 154 of the fifth lens 150 so that the light reaches each pixel of the image sensor 170.

Specifically, as in the embodiment of the present invention, when the first lens 110 has positive power, the second lens 120 has negative power, an absolute value of power P1 of the first lens 110 is 1.5 times or more an absolute value of power P2 of the second lens 120, and the center thickness CT1 of the first lens 110 is 2 times or more the center thickness CT2 of the second lens, the first lens 110 may collect light incident on the optical system 100, and the second lens 120 may correct chromatic aberration.

Further, when the distance T34 between the first lens group G1 and the second lens group G2 is the greatest among the distances between neighboring lenses in the optical system 100, and the distance T45 between the fourth lens 140 and the fifth lens 150 in the second lens group G2 is greater than the distance T12 between the first lens 110 and the second lens 120 in the first lens group G1 and the distance T23 between the second lens 120 and the third lens 130 in the first lens group G1, the second lens group G2 may serve to spread light more uniformly to the periphery of the image sensor.

According to the embodiment of the present invention, a total track length (TTL) which is a distance from the object-side surface 112 of the first lens 110 to the image sensor 170 is 4 mm to 4.5 mm, preferably 4.35 mm, a distance from the object-side surface 122 of the second lens 120 to the image sensor 170 is 3.5884 mm, a distance from the object-side surface 132 of the third lens 130 to the image sensor 170 is 3.3084 mm, a distance from the object-side surface 142 of the fourth lens 140 to the image sensor 170 is 2.2841 mm, and a distance from the object-side surface 152 of the fifth lens 150 to the image sensor 170 is 1.136 mm. Further, a back focal length (BFL) which is a distance from the image-side surface 154 of the fifth lens 150 to the image sensor 170 is 0.7287 mm. Further, a diagonal length (2*H_{imageD})) of the image sensor 170 is 6.53801 mm. From the point of view of those skilled in the art, the BFL should be implemented at 0.6 mm or more in consideration of assembly performance. For example, in the case of a camera device having an autofocusing function, the BFL should be implemented at 0.7 mm or more for the assembly of the optical system and the image sensor, and when the optical system includes a circular asymmetrical lens, the BFL should be implemented at 0.7 mm or more. Since the optical system of the present invention includes a circular asymmetrical lens, the BFL should be implemented at 0.7 mm or more. Accordingly, the optical system 100 may be implemented in a compact size and may be built into a front side as well as a rear side of a mobile terminal.

According to the embodiment of the present invention, a maximum effective diameter of the lenses included in the first lens group G1 may be greater than a minimum effective diameter of the lenses included in the second lens group G2. Here, the effective diameter may mean a diameter of an effective region of the object-side surface or the image-side surface on which light is incident.

In this case, a maximum effective diameter (ED_{G1_max}) of the lenses included in the first lens group G1 may be greater than a minimum effective diameter (ED_{G1_min}) of the lenses included in the first lens group G. The maximum effective diameter (ED_{G1_max}) of the lenses included in the first lens group G1 may be 1 to 1.5 times the minimum effective diameter (ED_{G1_min}) of the lenses included in the first lens group G1. Since the minimum effective diameter (ED_{G1_min}) of the lenses included in the first lens group G1 is the effective diameter of the object-side surface 112 of the first lens 110, the effective diameters of the image-side surface 114 of the first lens 110, the object-side surface 122 and image-side surface 124 of the second lens 120, and the object-side surface 132 and image-side surface 134 of the third lens 130 may be 1 to 1.5 times the effective diameter of the object-side surface 112 of the first lens 110.

Further, the effective diameters of the fourth lens 140 and the fifth lens 150 may gradually increase from the object side to the image side. For example, an effective diameter (ED_{L4S2}) of the image-side surface 144 of the fourth lens 140 may be larger than an effective diameter (ED_{L4S1}) of the object-side surface 142 of the fourth lens 140, an effective diameter (ED_{L5S1}) of the object-side surface 152 of the fifth lens 150 may be larger than the effective diameter (ED_{L4S2}) of the image-side surface 144 of the fourth lens 140, and an effective diameter (ED_{L5S2}) of the image-side surface 154 of the fifth lens 150 may be larger than the effective diameter (ED_{L5S1}) of the object-side surface 152 of the fifth lens 150.

Further, the maximum effective diameter (ED_{G1_max}) of the lenses included in the first lens group G1 may be 0.7 times or less, preferably 0.6 times or less, and more preferably 0.5 times or less the effective diameter (ED_{L5S2}) of the image-side surface 154 of the fifth lens 150.

Accordingly, the first lens group G1 serves to collect light incident on the optical system 100 to adjust an incident angle of light incident on the second lens group G2. Further, the second lens group G2 may serve to disperse light incident on the second lens group G2 after passing through the first lens group G1 to increase the amount of light which reaches the periphery of the image sensor 170.

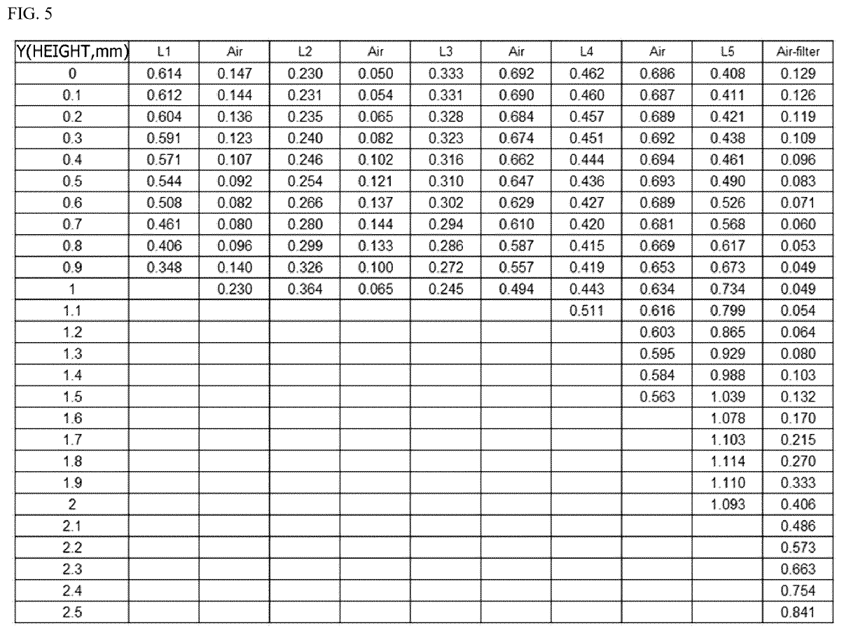

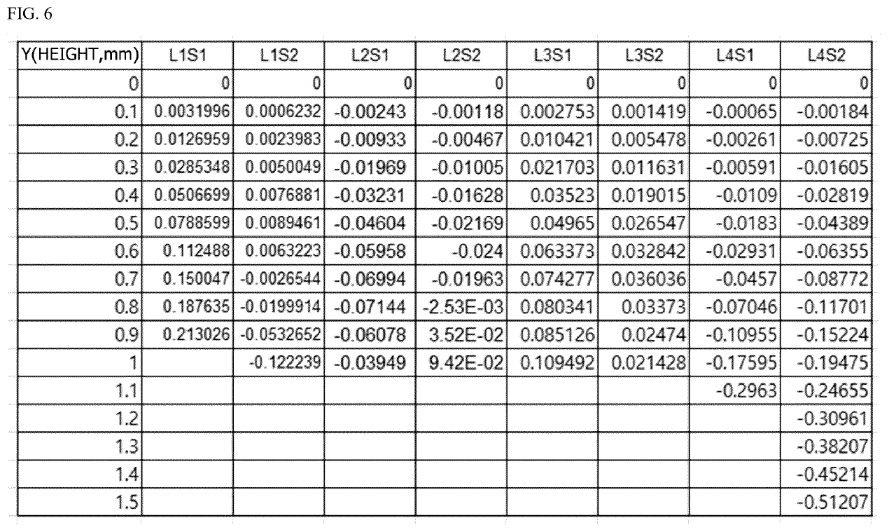

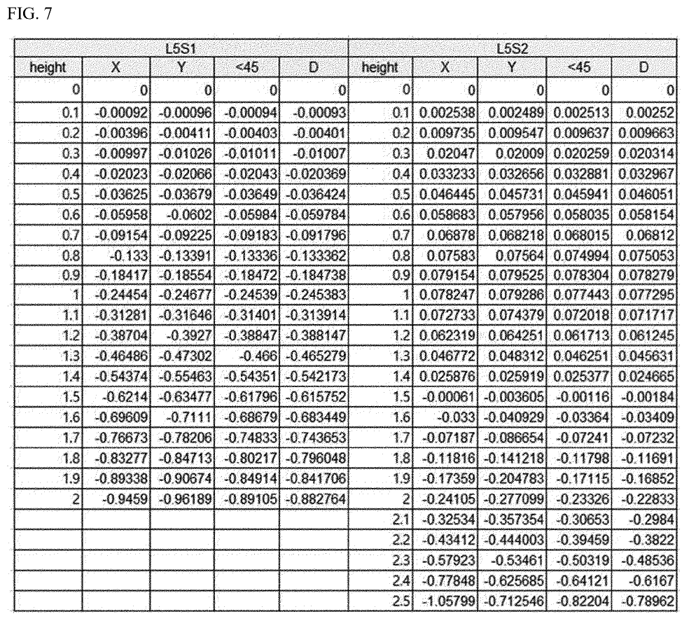

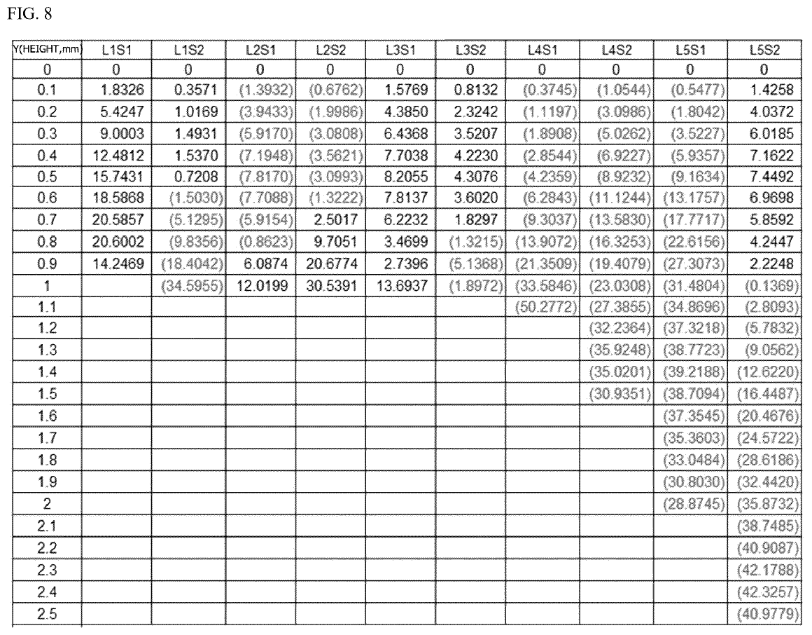

FIG. 5 is design data showing distances between lens surfaces according to a distance in a Y direction from an optical axis in the optical system according to the embodiment of the present invention, FIG. 6 is design data showing sag values of lens surfaces according to a distance in the Y direction from the optical axis on the first to fourth lenses of the optical system according to the embodiment of the present invention, FIG. 7 is design data showing the sag values of lens surfaces according to distances in the X direction, the Y direction, a diagonal direction, and a 45 degrees direction from the optical axis on the fifth lens of the optical system according to the embodiment of the present invention, and FIG. 8 is design data showing tilt angles of lens surfaces according to a distance in the Y direction from the optical axis in the optical system according to the embodiment of the present invention. In FIGS. 5 to 8, L1, L2, L3, L4, and L5 respectively mean the first lens 110, the second lens 120, the third lens 130, the fourth lens 140, and the fifth lens 150, and L1S1, L1S2, L2S1, L2S2, L3S1, L3S2, L4S1, L4S2, L5S1, and L5S2 respectively represent the object-side surface 112 and the image-side surface 114 of the first lens 110, the object-side surface 122 and the image-side surface 124 of the second lens 120, the object-side surface 132 and the image-side surface 134 of the third lens 130, the object-side surface 142 and the image-side surface 144 of the fourth lens 140, and the object-side surface 152 and the image-side surface 154 of the fifth lens 150. Air between L1 and L2 represents the distance between the first lens 110 and the second lens 120, air between L2 and L3 represents the distance between the second lens 120 and the third lens 130, air between L3 and L4 represents the distance between the third lens 130 and the fourth lens 140, and air between L4 and L5 represents the distance between the fourth lens 140 and the fifth lens 150.

Referring to FIG. 5, the distance between the image-side surface 114 of the first lens 110 and the object-side surface 122 of the second lens 120 may be uniformly maintained from the optical axis to an end of the image-side surface 114 of the first lens 110. Here, the end of the surface of the lens may mean an end of an effective region of the surface of the lens. Here, the optical axis may mean a point where a distance in the Y direction is 0. Here, when a ratio of a maximum distance to a minimum distance between the facing surfaces of different lenses from the optical axis to the end of the surface of the lens is 3 times or less, it may be interpreted that the distance between the facing surfaces of different lenses is uniformly maintained.

That is, a ratio of a maximum distance (T12ₘₐₓ) to a minimum distance (T12ₘᵢₙ) between the image-side surface 114 of the first lens 110 and the object-side surface 122 of the second lens 120 from the optical axis to the end of the image-side surface 114 of the first lens 110 may be 3 times or less.

Similarly, the distance between the image-side surface 124 of the second lens 120 and the object-side surface 132 of the third lens 130 may be uniformly maintained from the optical axis to an end of the image-side surface 124 of the first lens 120. That is, a ratio of a maximum distance (T23ₘₐₓ) to a minimum distance (T23ₘᵢₙ) between the image-side surface 124 of the second lens 120 and the object-side surface 132 of the third lens 130 from the optical axis to the end of the image-side surface 124 of the second lens 120 may be 3 times or less.

Similarly, the distance between the image-side surface 134 of the third lens 130 and the object-side surface 142 of the fourth lens 140 may be uniformly maintained from the optical axis to an end of the image-side surface 134 of the third lens 130. That is, a ratio of a maximum distance (T34ₘₐₓ) to a minimum distance (T34ₘᵢₙ) between the image-side surface 134 of the third lens 130 and the object-side surface 142 of the fourth lens 140 from the optical axis to the end of the image-side surface 134 of the third lens 130 may be 3 times or less, preferably 2 times or less, and more preferably 1.5 times or less.

Similarly, the distance between the image-side surface 144 of the fourth lens 140 and the object-side surface 152 of the fifth lens 150 may be maintained uniformly from the optical axis to an end of the image-side surface 144 of the fourth lens 140. That is, a ratio of a maximum distance (T45ₘₐₓ) to a minimum distance (T45ₘᵢₙ) between the image-side surface 144 of the fourth lens 140 and the object-side surface 152 of the fifth lens 150 from the optical axis to the end of the image-side surface 144 of the fourth lens 140 may be 3 times or less, preferably 2 times or less, more preferably 1.5 times or less, and more preferably 1.3 times.

Meanwhile, referring to FIGS. 6 to 8, according to the embodiment of the present invention, at least one surface of at least one of the first to fifth lenses forming the optical system 100 includes a critical point. The critical point may mean a point where the trend of the sag value changes. The sag value means a distance on the optical axis between any point on the lens surface and a point on the optical axis. The point where the trend of the sag value changes may be a point where the sag value increases and then decreases, or a point where the sag value decreases and then increases. The critical point may mean a point where the tilt angle becomes 0. The tilt angle may be defined as an angle formed by the normal line to the tangent of the lens surface and the optical axis.

According to the embodiment of the present invention, at least one of the six surfaces of the first lens 110, the second lens 120, and the third lens 130 includes a critical point. For example, according to the embodiment of the present invention, at least one of the image-side surface 114 of the first lens 110, the object-side surface 122 of the second lens 120, the image-side surface 124 of the second lens 120, and the image-side surface 134 of the third lens 130 includes a critical point. Light is more effectively refracted near the critical point. That is, light passing through a lens surface including the critical point may be more effectively refracted compared to the light passing through a lens surface not including the critical point. Thus, when at least one of the six surfaces of the first lens 110, the second lens 120, and the third lens 130 includes the critical point and when the effective diameter of the object-side surface 112 of the first lens 110 is designed to be small to minimize the head size, or even when a maximum effective diameter in the first lens group G1 is designed to be smaller than a minimum effective diameter in the second lens group G2 to minimize the head size, light incident through the effective diameter of the object-side surface 112 of the first lens 110 may be refracted in the widest possible range between the first to third lenses, the light may uniformly reach the peripheral pixels of the image sensor 170, and the performance of the optical system 100 may be enhanced.

Further, according to the embodiment of the present invention, at least two of the object-side surface 142 and the image-side surface 144 of the fourth lens 140 and the object-side surface 152 of the fifth lens 150 do not include critical points, and the image-side surface 154 of the fifth lens 150 may include a critical point. According to the embodiment of the present invention, the object-side surface 142 and image-side surface 144 of the fourth lens 140 and the object-side surface 152 of the fifth lens 150 may not include critical points, and the image-side surface 154 of the fifth lens 150 may include a critical point. Light is more effectively refracted near the critical point. When the critical point is present on the periphery of the image-side surface 154 of the fifth lens 150 which is a lens surface closest to the image sensor 170, it may be easy for the light refracted at the periphery of the image-side surface 154 of the fifth lens 150 to uniformly reach the peripheral pixels of the image sensor 170. The periphery may be a region closer to the effective diameter region than the optical axis. Specifically, when the critical point is present on the image-side surface 154 of the fifth lens 150 which is the lens surface closest to the image sensor 170, the assembly performance of the optical system 100 may be improved compared to when the critical point is present on the image-side surface or the object-side surface of the first lens 110 which is a lens surface farthest from the image sensor 170. Even when the fifth lens 150 is slightly tilted during assembly, since the assembly of the first to fourth lenses of the optical system 100 is not affected and thus the optical performance is not significantly affected, the assembly performance of the optical system 100 may be improved. When the critical point is present on the image-side surface or object-side surface of the first lens 110 which is the lens surface farthest from the image sensor 170 and the first lens is tilted and assembled during the assembly, since the tilt of the assembly affect the second lens and the fifth lens which are the remaining lenses, the performance of the optical system is significantly lowed.

More specifically, according to the embodiment of the present invention, the critical point of the image-side surface 114 of the first lens 110 may be a point having a vertical distance of 0.5 mm to 0.6 mm from the optical axis. For example, when the optical axis is a starting point and the end of the image-side surface 114 of the first lens 110 is an end point, the critical point of the image-side surface 114 of the first lens 110 may be disposed at a position which is about 50% to 60%. Here, the end of the surface of the lens may mean the end of the effective region of the surface of the lens, and the position of the critical point may be a position set based on a direction perpendicular to the optical axis.

According to the embodiment of the present invention, the critical point of the object-side surface 122 of the second lens 120 may be a point having a vertical distance of 0.8 mm to 0.9 mm from the optical axis. For example, when the optical axis is a starting point and the end of the object-side surface 122 of the second lens 120 is an end point, the critical point of the object-side surface 122 of the second lens 120 may be disposed at a position which is about 80% to 90%.

According to the embodiment of the present invention, the critical point of the image-side surface 124 of the second lens 120 may be a point having a vertical distance of 0.6 mm to 0.7 mm from the optical axis. For example, when the optical axis is a starting point and the end of the image-side surface 124 of the second lens 120 is an end point, the critical point of the image-side surface 124 of the second lens 120 may be disposed at a position which is about 60% to 70%.

According to the embodiment of the present invention, the critical point of the image-side surface 134 of the third lens 130 may be a point having a vertical distance of 0.7 mm to 0.8 mm from the optical axis. For example, when the optical axis is a starting point and the end of the image-side surface 134 of the third lens 130 is an end point, the critical point of the image-side surface 134 of the third lens 130 may be disposed at a position which is about 70% to 80%.

Thus, when the critical point is present on at least one of the six surfaces of the first to third lenses included in the first lens group G1, light may be uniformly dispersed in the first lens group G1, output through the image-side surface 134 of the third lens 130 of the first lens group G1, and incident on the object-side surface 142 of the fourth lens 140.

According to the embodiment of the present invention, the object-side surface 142 of the fourth lens 140, the image-side surface 144 of the fourth lens 140, and the object-side surface 152 of the fifth lens 150 do not include critical points, and the object-side surface 142 of the fourth lens 140 is concave toward the object side, the image-side surface 144 of the fourth lens 140 is convex toward the image side, and the object-side surface 152 of the fifth lens 150 is concave toward the object side. Further, an absolute value of a radius of curvature (R_{L4S2}) of the image-side surface 144 of the fourth lens 140 may be 0.9 to 1.1 times, and preferably 0.95 to 1.05 times an absolute value of a radius of curvature (R_{L5S1}) of the object-side surface 152 of the fifth lens 150. When the object-side surface 142 of the fourth lens 140, the image-side surface 144 of the fourth lens 140, and the object-side surface 152 of the fifth lens 150 satisfy the above conditions, light uniformly dispersed in the first lens group G1 and output through the image-side surface 134 of the third lens 130 of the first lens group G1 and then incident on the object-side surface 142 of the fourth lens 140 may be uniformly dispersed and then may be incident from the center to the periphery of the object-side surface 152 of the fifth lens 150.

According to the embodiment of the present invention, the first to fourth lenses are circular symmetrical lenses, and the fifth lens 150 is a lens whose both surfaces have a circular asymmetrical shape.

Referring to FIG. 7, both the object-side surface 152 and the image-side surface 154 of the fifth lens 150 have a circular asymmetrical shape. When both the object-side surface 152 and the image-side surface 154 of the fifth lens 150 have a circular asymmetrical shape, light distortion may be minimized, an optical angle may be implemented and the RI may be increased while reducing the total number of lenses included in the optical system 100. A circular asymmetrical shape may mean that shapes of the lens cross-sections are different in the X-axis and Y-axis directions around the optical axis, shapes of lens cross-sections are different in a third direction between the X-axis and Y-axis directions and the X-axis direction, or shapes of lens cross-sections are different in the third direction between the X-axis and Y-axis directions and the Y-axis direction. Here, the third direction may mean a diagonal direction of the image sensor or a 45 degrees direction between the X-axis and the Y-axis. When an X-axis length and a Y-axis length of the image sensor are the same, the diagonal direction of the image sensor and the 45 degrees direction between the X-axis and the Y-axis may be the same. When the X-axis length and Y-axis length of the image sensor are different, for example, when a ratio of the X-axis length to the Y-axis length of the image sensor is 4:3, an angle between the X-axis direction and the diagonal direction may be smaller than 45 degrees, and an angle between the Y-axis direction and the diagonal direction may be larger than 45 degrees. Here, a case in which the shapes are different may mean that tilt angles are different, sag values are different, or points where critical points appear are different when there are critical points. For example, a case in which the shapes in the X-axis direction and the Y-axis direction are different from each other may mean that a region where a tilt angle in the X-axis direction and a tilt angle in the Y-axis direction are different from each other for the same distance from the optical axis is present, or a region where a sag value in the X-axis direction and a sag value in the Y-axis direction are different from each other for the same distance from the optical axis is present. When the critical point is present, the case in which the shapes in the X-axis direction and the Y-axis direction are different from each other may mean that a distance between the optical axis and the critical point in the X-axis direction and a distance between the optical axis and the critical point in the Y-axis direction are different from each other. The circular asymmetrical shape may be used interchangeably with a free surface shape, an autonomous surface shape, a rotationally asymmetric shape, a free-form shape, an origin asymmetry, or the like.

According to the embodiment of the present invention, the sag value in the X-direction and the sag value in the Y-direction have a deviation on the object-side surface 152 of the fifth lens. As described above, the sag value means a distance on the optical axis between any point on the lens surface and a point on the optical axis. In FIG. 7, a case in which the sag value is positive means a shape protruding to the right from the optical axis, and a case in which the sag value is negative means a shape protruding to the left from the optical axis. It is apparent to those skilled in the art that the sign of the sag value may be defined in reverse. For example, a case in which the sag value is negative may also mean a shape protruding to the right from the optical axis, and a case in which the sag value is positive may also mean a shape protruding to the left from the optical axis. For example, a deviation between a sag value (Sag_{L5S1_X}) in the X direction and a sag value (Sag_{L5S1_Y}) in the Y direction on the object-side surface 152 of the fifth lens 150 may be 0.001 μm to 20 μm. For example, the deviation between the sag value (Sag_{L5S1_X}) in the X direction and the sag value (Sag_{L5S1_Y}) in the Y direction on the object-side surface 152 of the fifth lens 150 tends to increase as it gets farther away from the optical axis. For example, in a region where a vertical distance from the optical axis is 1 mm or less, the deviation between the sag value (Sag_{L5S1_X}) in the X direction and the sag value (Sag_{L5S1_Y}) in the Y direction on the object-side surface 152 of the fifth lens 150 may be 5 μm, preferably 3 μm or less, and more preferably 2 μm or less, and in a region where a vertical distance from the optical axis exceeds 1 mm, the deviation between the sag value (Sag_{L5S1_X}) in the X direction and the sag value (Sag_{L5S1_Y}) in the Y direction on the object-side surface 152 of the fifth lens 150 may be 2 μm to 20 μm, preferably from 3 μm to 20 μm, and more preferably from 5 μm to 20 μm.

Accordingly, light passing through the object-side surface 152 of the fifth lens 150 may be more uniformly dispersed and reach the peripheral pixels of the image sensor 170.

According to the embodiment of the present invention, the sag value (Sag_{L5S1_X}) in the X direction or the sag value (Sag_{L5S1_Y}) in the Y direction and a sag value (Sag_{L5S1_D}) in the diagonal direction may have a deviation on the object-side surface 152 of the fifth lens 150. Here, the diagonal direction may mean a diagonal direction between the X direction and the Y direction based on the image sensor. For example, when a ratio of the X direction and the Y direction of the image sensor is 1:1, the diagonal direction may mean a direction forming a 45 degrees angle between the X direction and the Y direction. On the contrary, when the ratio of the X direction and the Y direction of the image sensor is 3:4 or 4:3, the diagonal direction may be different from the direction forming the 45 degrees angle between the X direction and the Y direction. For example, the deviation between the sag value (Sag_{L5S1_X}) in the X direction or the sag value (Sag_{L5S1_Y}) in the Y direction and the sag value (Sag_{L5S1_D}) in the diagonal direction on the object-side surface 152 of the fifth lens 150 may be 0.001 μm to 100 μm. For example, the deviation between the sag value (Sag_{L5S1_X}) in the X direction or the sag value (Sag_{L5S1_Y}) in the Y direction and the sag value (Sag_{L5S1_D}) in the diagonal direction on the object-side surface 152 of the fifth lens 150 tends to increase as it gets farther away from the optical axis. Accordingly, light passing through the object-side surface 152 of the fifth lens 150 may be more uniformly dispersed and reach the peripheral pixels of the image sensor 170.

According to the embodiment of the present invention, based on the same distance from the optical axis, the deviation between the sag value (Sag_{L5S1_X}) in the X direction or the sag value (Sag_{L5S1_Y}) in the Y direction and the sag value (Sag_{L5S1_D}) in the diagonal direction on the object-side surface 152 of the fifth lens 150 may be greater than the deviation between the sag value (Sag_{L5S1_X}) in the X direction and the sag value (Sag_{L5S1_Y}) in the Y direction on the object-side surface 152 of the fifth lens 150. Accordingly, light passing through the object-side surface 152 of the fifth lens 150 may be more uniformly dispersed and reach the peripheral pixels of the image sensor 170. According to the embodiment of the present invention, a sag value (Sag_{L5S2_X}) in the X direction and a sag value (Sag_{L5S2_Y}) in the Y direction may have a deviation on the image-side surface 154 of the fifth lens 150. For example, the deviation between the sag value (Sag_{L5S2_X}) in the X direction and the sag value (Sag_{L5S2_Y}) in the Y direction on the image-side surface 154 of the fifth lens 150 may be 0.001 μm to 500 μm. For example, the deviation between the sag value (Sag_{L5S2_X}) in the X direction and the sag value (Sag_{L5S2_Y}) in the Y direction on the image-side surface 154 of the fifth lens 150 tends to increase as it gets farther away from the optical axis. For example, in a region where a vertical distance from the optical axis is 1 mm or less, the deviation between the sag value (Sag_{L5S2_X}) in the X direction and the sag value (Sag_{L5S2_Y}) in the Y direction on the object-side surface 152 of the fifth lens 150 may be 1 μm or less, and in a region where a vertical distance from the optical axis exceeds 1 mm, the deviation between the sag value (Sag_{L5S2_X}) in the X direction and the sag value (Sag_{L5S2_Y}) in the Y direction on the object-side surface 152 of the fifth lens 150 may be 1 μm to 500 μm, preferably 1 μm to 400 μm, and more preferably 1 μm to 350 μm. Accordingly, light passing through the image-side surface 154 of the fifth lens 150 may be more uniformly dispersed and reach the peripheral pixels of the image sensor 170. In addition, when at least one of the object-side surface 152 and the image-side surface 154 of the fifth lens 150 includes a circular asymmetrical shape, since an effect in that a plurality of lenses are disposed in an overlapping manner using a single lens may be acquired, optical performance may be increased while implementing the optical system 100 in a small size.

According to the embodiment of the present invention, the sag value (Sag_{L5S2_X}) in the X direction or the sag value (Sag_{L5S2_Y}) in the Y direction and a sag value (Sag_{L5S2_D}) in the diagonal direction may have a deviation on the image-side surface 154 of the fifth lens 150. Accordingly, light passing through the image-side surface 154 of the fifth lens 150 may be more uniformly dispersed and reach the peripheral pixels of the image sensor 170.

According to the embodiment of the present invention, based on the same distance from the optical axis, the deviation between the sag value (Sag_{L5S2_X}) in the X direction and the sag value (Sag_{L5S2_Y}) in the Y direction on the image-side surface 154 of the fifth lens 150 may be greater than the deviation between the sag value (Sag_{L5S1_X}) in the X direction and the sag value (Sag_{L5S1_Y}) in the Y direction on the object-side surface 152 of the fifth lens 150. Accordingly, since an effect in that a plurality of lenses are disposed in an overlapping manner using a single lens may be acquired, optical performance may be increased while implementing the optical system 100 in a small size.

According to the embodiment of the present invention, a maximum sag value (max_Sag_{L5S1_X}) in the X direction and a maximum sag value (max_Sag_{L5S1_Y}) in the Y direction of the object-side surface 152 of the fifth lens 150 may be different, and a maximum sag value (max_Sag_{L5S1_X}) in the X direction and a maximum sag value (max_Sag_{L5S1_Y}) in the Y direction of the image-side surface 154 of the fifth lens 150 may be different. Here, the maximum sag value (max_Sag_{L5S1_X}) in the X direction means a maximum sag value among the sag values acquired along the X direction from the optical axis, and the maximum sag value (max_Sag_{L5S1_Y}) in the Y direction means a maximum sag value among the sag values acquired along the Y direction from the optical axis.

According to the embodiment of the present invention, the maximum sag value (max_Sag_{L5S1_X}) in the X direction or the maximum sag value (max_Sag_{L5S1_Y}) in the Y direction of the object-side surface 152 of the fifth lens 150 may be different from a maximum sag value (max_Sag_{L5S1_D}) in the diagonal direction.

According to the embodiment of the present invention, a deviation between the maximum sag value (max_Sag_{L5S1_X}) in the X direction or the maximum sag value (max_Sag_{L5S1_Y}) in the Y direction and the maximum sag value (max_Sag_{L5S1_D}) in the diagonal direction of the object-side surface 152 of the fifth lens 150 may be greater than a deviation between the maximum sag value (max_Sag_{L5S1_X}) in the X direction and the maximum sag value (max_Sag_{L5S1_Y}) in the Y direction of the object-side surface 152 of the fifth lens 150.

According to the embodiment of the present invention, a deviation between a maximum sag value (max_Sag_{L5S2_X}) in the X direction and a maximum sag value (max_Sag_{L5S2_Y}) in the Y direction of the image-side surface 154 of the fifth lens 150 may be greater than the deviation between the maximum sag value (max_Sag_{L5S1_X}) in the X direction and the maximum sag value (max_Sag_{L5S1_X}) in the Y direction of the object-side surface 152 of the fifth lens 150. For example, the deviation between the maximum sag value (max_Sag_{L5S2_X}) in the X direction and the maximum sag value (max_Sag_{L5S2_Y}) in the Y direction of the image-side surface 154 of the fifth lens 150 may be 10 times or more the deviation between the maximum sag value (max_Sag_{L5S1_X}) in the X direction and the maximum sag value (max_Sag_{L5S1_Y}) in the Y direction of the object-side surface 152 of the fifth lens 150. Accordingly, since an effect in that a plurality of lenses are disposed in an overlapping manner using a single lens may be acquired, optical performance may be increased while implementing the optical system 100 in a small size.

Thus, when both the object-side surface 152 and the image-side surface 154 of the fifth lens 150 have a circular asymmetrical shape, the distortion of light passing through the fifth lens 150 may be minimized, and the light passing through the fifth lens 150 may be uniformly dispersed. Accordingly, since an effect in that a plurality of lenses are disposed in an overlapping manner using a single lens may be acquired, optical performance may be increased while implementing the optical system 100 in a small size.

According to the embodiment of the present invention, the critical point of the image-side surface 152 of the fifth lens 150 may be a point having a vertical distance of 0.9 mm to 1 mm from the optical axis. According to the embodiment of the present invention, the critical point of the image-side surface 154 of the fifth lens 150 may be disposed in a region where a vertical distance from the optical axis is 1 mm or less, that is, in a region where the deviation between the sag value (max_Sag_{L5S1_X}) in the X direction and the sag value (max_Sag_{L5S2_Y}) in the Y direction on the object-side surface 152 of the fifth lens 150 is 1 μm or less. Accordingly, the dispersion characteristics of light passing through the image-side surface 154 of the fifth lens 150 may be maximized.

Referring to FIG. 8, according to the embodiment of the present invention, a maximum tilt angle from the optical axis to the critical point of the image-side surface 154 of the fifth lens 150 may be larger than a maximum tilt angle from the critical point to an edge of the image-side surface 154 of the fifth lens 150. For example, the maximum tilt angle from the optical axis to the critical point of the image-side surface 154 of the fifth lens 150 may be 5 to 7 times the maximum tilt angle from the critical point to the edge of the image-side surface 154 of the fifth lens 150. In this case, the maximum tilt angle may be 65 degrees or less within a range of 60 to 90% of an effective diameter of the image-side surface 154 of the fifth lens 150. Accordingly, manufacturing performance may be improved while satisfying optical performance.

Accordingly, the dispersion characteristics of light passing through the image-side surface 154 of the fifth lens 150 may be maximized, and the RI may be improved.

The optical system 100 according to the embodiment of the present invention may satisfy at least one of the conditional equations described below. Accordingly, the optical system 100 according to the embodiment of the present invention may have an optically enhanced effect. Specifically, the optical system 100 according to the embodiment of the present invention may acquire optical performance in which the effective focal length (EFL) is 3.76 mm, the F number is 2.45 or less, the FOV in the diagonal direction is 80 degrees or more, and the RI is 40% or more in the 1 field under the condition that a half value of a diagonal length of a pixel region of the image sensor 170 (H_{imageD}) is 3.2690 mm.

$${ED}_{L 1 S 1} \leq EPD \qquad [ Equation 1 ]$$

Here, ED_{L1S1} is the effective diameter of the object-side surface 112 of the first lens 110, and an entrance pupil diameter (EPD) is a diameter of an entrance pupil. Accordingly, since the area of the object-side surface112 of the first lens 110 exposed to the outside may be minimized, the head size of the optical system 100 may be minimized.

$${ED}_{L 1 S 1} < 0. {3}^{*} 2 {H}_{i m a g e D} \qquad [ Equation 2 - 1 ]$$

$${ED}_{L 1 S 1} < {0.5}^{*} 2 {H}_{i m a g e D} \qquad [ Equation 2 - 2 ]$$

$${ED}_{L 1 S 1} < {0.7}^{*} 2 {H}_{i m a g e D} \qquad [ Equation 2 - 3 ]$$

Here, H_{imageD} is a half value of the diagonal length of the pixel region of the image sensor 170. According to [Equation 2-1] to [Equation 2-3], since an area where the object-side surface 112 of the first lens 110 is exposed to the outside may be minimized within a range in which the first lens 110 can be manufactured, the head size of the optical system 100 may be minimized.

$$3 mm \leq T T L \leq 6.5 mm \qquad [ Equation 3 - 1 ]$$

$$3 mm \leq T T L \leq 5.5 mm \qquad [ Equation 3 - 2 ]$$

$$4 mm \leq T T L \leq 4.5 mm \qquad [ Equation 3 - 3 ]$$

Here, TTL is a distance from the object-side surface 112 of the first lens 110 to the image sensor 170. When the TTL is smaller than the lower limit of [Equation 3-1] to [Equation 3-3], manufacturability is poor and it may be difficult to achieve a preferable effective focal length, and when the TTL exceeds the upper limit of [Equation 3-1] to [Equation 3-3], the size of the camera device increases and thus it may be difficult to implement the camera device in a compact size in a mobile terminal.

$$0.9 \leq TTL / EFL \leq 1.4 \qquad [ Equation 4 - 1 ]$$

$$1. \leq TTL / EFL \leq 1.3 \qquad [ Equation 4 - 2 ]$$

$$1.06 \leq TTL / EFL \leq 1.2 \qquad [ Equation 4 - 3 ]$$

Here, EFL is an effective focal length. According to [Equation 4-1] to [Equation 4-3], a high-resolution image may be acquired even in a narrow space.

$$0.5 \leq TTL / {2}^{*} {H}_{i m a g e D} \leq 0.9 \qquad [ Equation 5 - 1 ]$$

$$0.55 \leq TTL / {2}^{*} {H}_{i m a g e D} \leq 0.8 \qquad [ Equation 5 - 2 ]$$

$$0.61 \leq TTL / {2}^{*} {H}_{i m a g e D} \leq 0.69 \qquad [ Equation 5 - 3 ]$$

According to [Equation 5-1] to [Equation 5-3], a high-resolution image may be acquired even in a narrow space.

$$2.56 \leq TTL / EPD \leq 2.89 \qquad [ Equation 6 ]$$

Accordingly, the head size of the optical system 100 and the overall size of the camera device may be miniaturized

$$1.46 \leq E {D}_{L 1 S 1} \leq 1.96 \qquad [ Equation 7 ]$$

Accordingly, the head size of the optical system 100 may be miniaturized

$$CT 1 > CT 2 + CT 3 \qquad [ Equation 8 ]$$

Here, CT1 is a center thickness of the first lens 110, CT2 is a center thickness of the second lens 120, and CT3 is a center thickness of the third lens 130. Accordingly, light may be collected by the first lens group G1 without distortion even when the effective diameter of the object-side surface 112 of the first lens 110 is sufficiently small, and the first lens group G1 may serve to collect light and correct chromatic aberration.

$$2 \leq CT 1 / CT 2 \qquad [ Equation 9 ]$$

Accordingly, light may be collected by the first lens group G1 without distortion even when the effective diameter of the object-side surface 112 of the first lens 110 is sufficiently small, and the first lens group G1 may serve to collect light and correct chromatic aberration.

$$CT 1 > CT 4 \qquad [ Equation 10 ]$$

Here, CT4 is a center thickness of the fourth lens 140.

Accordingly, light may be collected by the first lens group G1 without distortion even when the effective diameter of the object-side surface 112 of the first lens 110 is sufficiently small, and the second lens group G2 may serve to uniformly spread light to each peripheral pixel of the image sensor.

$$CT 1 > CT 5 \qquad [ Equation 11 ]$$

Here, CT5 is a center thickness of the fifth lens 150. Accordingly, light may be collected by the first lens group G1 without distortion even when the effective diameter of the object-side surface 112 of the first lens 110 is sufficiently small, and the second lens group G2 may serve to uniformly spread light to each peripheral pixel of the image sensor.

$$T 34 > T 12 \qquad [ Equation 12 ]$$

Here, T34 is a distance between the third lens 130 and the fourth lens 140, and T12 is a distance between the first lens 110 and the second lens 120. Accordingly, light may be collected without distortion even when the effective diameter of the object-side surface 112 of the first lens 110 is sufficiently small, and the light collected by the first lens group G1 may pass through the second lens group G2 and uniformly reach each pixel of the image sensor 170 without distortion.

$$T 34 > T 23 \qquad [ Equation 13 ]$$

Here, T34 is a distance between the third lens 130 and the fourth lens 140, and T23 is a distance between the second lens 120 and the third lens 130. Accordingly, light may be collected without distortion even when the effective diameter of the object-side surface 112 of the first lens 110 is sufficiently small, and the light collected by the first lens group G1 may pass through the second lens group G2 and uniformly reach each pixel of the image sensor 170 without distortion.

$$T 45 \leq T 34 \qquad [ Equation 14 ]$$

Here, T34 is a distance between the third lens 130 and the fourth lens 140, and T45 is a distance between the fourth lens 140 and the fifth lens 150. Accordingly, the light collected by the first lens group G1 may pass through the second lens group G2 and uniformly reach each pixel of the image sensor 170 without distortion.

$$0.75 \leq T 34 / T 45 \leq 1.3 \qquad [ Equation 15 - 1 ]$$

$$0.85 \leq T 34 / T 45 \leq 1.2 \qquad [ Equation 15 - 2 ]$$

$$0.95 \leq T 34 / T 45 \leq 1.1 \qquad [ Equation 15 - 3 ]$$

According to [Equation 15-1] to [Equation 15-3], the light collected by the first lens group G1 may pass through the second lens group G2 and uniformly reach each pixel of the image sensor 170 without distortion.

$$T 45 > T 12 \qquad [ Equation 16 ]$$

Accordingly, the first lens group G1 may serve to collect light and correct chromatic aberration, and the second lens group G2 may serve to uniformly spread light to each peripheral pixel of the image sensor.

$$T 45 > T 23 \qquad [ Equation 17 ]$$

Accordingly, the first lens group G1 may serve to collect light and correct chromatic aberration, and the second lens group G2 may serve to uniformly spread light to each peripheral pixel of the image sensor.

$$1.5 \leq \vert P 1 \vert / \vert P 2 \vert \qquad [ Equation 18 ]$$

Here, P1 is power of the first lens 110 and P2 is power of the second lens 120. Accordingly, the first lens 110 may collect light incident on the optical system 100 and the second lens 120 may correct chromatic aberration. Preferably, |P1|/|P2| may be 1.6 or more

$$1 \leq E {D}_{G 1\_ max} / E {D}_{G 1\_ min} \leq 1.5 \qquad [ Equation 19 ]$$

Here, ED_{G1_max} is a maximum effective diameter in the first lens group and ED_{G1_min} is a minimum effective diameter in the first lens group. Accordingly, the first lens group G1 may serve to collect light incident on the optical system 100. Preferably, ED_{G1_max}/ED_{G1_min} may be 1 or more and 1.35 or less.

$$E {D}_{L 4 S 1} < E {D}_{L 4 S 2} < E {D}_{L 5 S 1} < E {D}_{L 5 S 2} \qquad [ Equation 20 ]$$

Here, ED_{L4S1} is an effective diameter of the object-side surface 142 of the fourth lens 140, ED_{L4S2} is an effective diameter of the image-side surface 144 of the fourth lens 140, ED_{L5S1} is an effective diameter of the object-side surface 152 of the fifth lens 150, and ED_{L5S2} is an effective diameter of the image-side surface 154 of the fifth lens 120. Accordingly, the second lens group G2 may serve to disperse the light incident on the second lens group G2 after passing through the first lens group G1 to increase an amount of light which reaches the periphery of the image sensor 170.

$${ED}_{G 1\_ max} / {ED}_{L 5 S 2} \leq 0.7 \qquad [ Equation 21 ]$$

Here, ED_{G1_max} is the maximum effective diameter in the first lens group, and ED_{L5S2} is the effective diameter of the image-side surface 154 of the fifth lens 150. Accordingly, the first lens group G1 may serve to collect the light incident on the optical system 100 to adjust an incident angle of light incident on the second lens group G2. Further, the second lens group G2 may serve to disperse light incident on the second lens group G2 after passing through the first lens group G1 to increase the amount of light which reaches the periphery of the image sensor 170. Preferably, ED_{G1_max}/ED_{L5S2} may be 0.6 or less.

$$T 1 {2}_{max} / T {12}_{min} \leq 3 \qquad [ Equation 22 ]$$

Here, T12ₘₐₓ is a maximum distance between the image-side surface 114 of the first lens 110 and the object-side surface 122 of the second lens 120, and T12ₘᵢₙ is a minimum distance between the image-side surface 114 of the first lens 110 and the object-side surface 122 of the second lens 120. Accordingly, light may reach the object-side surface 122 of the second lens 120 from the image-side surface 114 of the first lens 110 without spreading.

$$T 2 {3}_{max} / T {23}_{min} \leq 3 \qquad [ Equation 23 ]$$

Here, T23ₘₐₓ is a maximum distance between the image-side surface 124 of the second lens 120 and the object-side surface 132 of the third lens 130, and T23ₘᵢₙ is a minimum distance between the image-side surface 124 of the second lens 120 and the object-side surface 132 of the third lens 130. Accordingly, light may reach the object-side surface 132 of the third lens 130 from the image-side surface 124 of the second lens 120 in a collected state without being dispersed.

$$T 3 {4}_{max} / T {34}_{min} \leq 3 \qquad [ Equation 24 ]$$

Here, T34ₘₐₓ is a maximum distance between the image-side surface 134 of the third lens 130 and the object-side surface 142 of the fourth lens 140, and T34ₘᵢₙ is a minimum distance between the image-side surface 134 of the third lens 130 and the object-side surface 142 of the fourth lens 140. Accordingly, light may reach the object-side surface 142 of the fourth lens 140 from the image-side surface 134 of the third lens 130 in a collected state without being dispersed. Preferably, T34ₘₐₓ/T34ₘᵢₙ may be 2 or less.

$$T 4 {5}_{max} / T {45}_{min} \leq 3 \qquad [ Equation 25 ]$$

Here, T45ₘₐₓ is a maximum distance between the image-side surface 144 of the fourth lens 140 and the object-side surface 152 of the fifth lens 150, and T45ₘᵢₙ is a minimum distance between the image-side surface 144 of the fourth lens 140 and the object-side surface 152 of the fifth lens 150. Accordingly, light may reach the object-side surface 152 of the fifth lens 150 from the image-side surface 144 of the fourth lens 140 in a collected state without being dispersed. Preferably, T45ₘₐₓ/T45ₘᵢₙ may be 2 or less.

$$0 \text{.9} \leq \vert {R}_{L 4 S 2} / {R}_{L 5 S 1} \vert \leq 1. 1 \qquad [ Equation 26 ]$$

Here, R_{L4S2} is a radius of curvature of the image-side surface 144 of the fourth lens 140, and R_{L5S1} is a radius of curvature of the object-side surface 152 of the fifth lens 150. Accordingly, light uniformly dispersed in the first lens group G1 and output through the image-side surface 134 of the third lens 130 of the first lens group G1 and then incident on the object-side surface 142 of the fourth lens 140 may be uniformly dispersed and then may be incident on the image sensor from the center to the periphery of the object-side surface 152 of the fifth lens 150. Preferably, |R_{L4S2}/R_{L5S1}| may be 0.95 or more and 1.05 or less.

$$0.001 μm \leq \vert {Sag}_{L 5 S 1\_ X} - {Sag}_{L 5 S 1\_ Y} \vert \leq 20 μm \qquad [ Equation 27 ]$$

Here, Sag_{L5S1_X} is a sag value in the X direction of the object-side surface 152 of the fifth lens 150, and Sag_{L5S1_Y} is a sag value in the Y direction of the object-side surface 152 of the fifth lens 150. Accordingly, light passing through the object-side surface 152 of the fifth lens 150 may be more uniformly dispersed and reach the peripheral pixels of the image sensor 170.

$$0.001 μm \leq \vert {Sag}_{L 5 S 1\_ X} - {Sag}_{L 5 S 1\_ D} \vert \leq 100 μm \qquad [ Equation 28 ]$$

Here, Sag_{L5S1_D} is a sag value in the diagonal direction of the object-side surface 152 of the fifth lens 150. Accordingly, light passing through the object-side surface 152 of the fifth lens 150 may be more uniformly dispersed and reach the peripheral pixels of the image sensor 170.

$$0.001 μm \leq \vert {Sag}_{L 5 S 1\_ Y} - {Sag}_{L 5 S 1\_ D} \vert \leq 100 μm \qquad [ Equation 29 ]$$

Accordingly, light passing through the object-side surface 152 of the fifth lens 150 may be more uniformly dispersed and reach the peripheral pixels of the image sensor 170.

$$\vert {Sag}_{L 5 S 1\_ X} - {Sag}_{L 5 S 1\_ Y} \vert < \vert {Sag}_{L 5 S 1\_ X} - {Sag}_{L 5 S 1\_ D} \vert \qquad [ Equation 30 ]$$

Accordingly, light passing through the object-side surface 152 of the fifth lens 150 may be more uniformly dispersed and reach the peripheral pixels of the image sensor 170. Further, since an effect in that a plurality of lenses are disposed in an overlapping manner using a single fifth lens 150 may be acquired, optical performance may be increased while implementing the optical system 100 in a small size.

$$\vert {Sag}_{L 5 S 1\_ X} - {Sag}_{L 5 S 1 \_ Y} \vert < \vert {Sag}_{L 5 S 1\_ Y} - {Sag}_{L 5 S 1\_ D} \vert \qquad [ Equation 31 ]$$

Accordingly, light passing through the object-side surface 152 of the fifth lens 150 may be more uniformly dispersed and reach the peripheral pixels of the image sensor 170. In addition, since an effect in that a plurality of lenses are disposed in an overlapping manner using a single fifth lens 150 may be acquired, optical performance may be increased while implementing the optical system 100 in a small size.

$$0.001 μm \leq \vert {Sag}_{L 5 S 2\_ X} - {Sag}_{L 5 S 2\_ Y} \vert \leq 500 μm \qquad [ Equation 32 ]$$

Here, Sag_{L5S2_X} is a sag value in the X direction of the image-side surface 154 of the fifth lens 150, and Sag_{L5S2_Y} is a sag value in the Y direction of the image-side surface 154 of the fifth lens 150. Accordingly, light passing through the object-side surface 152 of the fifth lens 150 may be more uniformly dispersed and reach the peripheral pixels of the image sensor 170. Further, since an effect in that a plurality of lenses are disposed in an overlapping manner using a single fifth lens 150 may be acquired, optical performance may be increased while implementing the optical system 100 in a small size. Preferably, |Sag_{L5S2_X}−Sag_{L5S2_Y}| may be 0.001 μm or more and 400 μm or less.

$$\vert {Sag}_{L 5 S 1\_ X} - {Sag}_{L 5 S 1\_ Y} \vert < \vert {Sag}_{L 5 S 2\_ X} - {Sag}_{L 5 S 2\_ Y} \vert \qquad [ Equation 33 ]$$

Accordingly, since an effect in that a plurality of lenses are disposed in an overlapping manner using a single lens may be acquired, optical performance may be increased while implementing the optical system 100 in a small size.

$$\vert {max\_Sag}_{L 5 S 1\_ X} - {max\_Sag}_{L 5 S 1\_ Y} \vert < \vert {max\_Sag}_{L 5 S 1\_ X} - {max\_Sag}_{L 5 S 1\_ D} \vert \qquad [ Equation 34 ]$$

Here, max_Sag_{L5S1_X} is a maximum sag value in the X direction of the object-side surface 152 of the fifth lens 150, max_Sag_{L5S1_Y} is a maximum sag value in the Y direction of the object-side surface 152 of the fifth lens 150, and max_Sag_{L5S1_D} is a maximum sag value in the diagonal direction of the object-side surface 152 of the fifth lens 150. Accordingly, since an effect in that a plurality of lenses are disposed in an overlapping manner may be acquired using a single lens, optical performance may be increased while implementing the optical system 100 in a small size.

$$\vert {max\_Sag}_{L 5 S 1\_ X} - {max\_Sag}_{L 5 S 1\_ Y} \vert < \vert {max\_Sag}_{L 5 S 1\_ Y} - {max\_Sag}_{L 5 S 1\_ D} \vert \qquad [ Equation 35 ]$$

Accordingly, since an effect in that a plurality of lenses are disposed in an overlapping manner using a single lens may be acquired, optical performance may be increased while implementing the optical system 100 in a small size.

$$\vert {max\_Sag}_{L 5 S 1\_ X} - {max\_Sag}_{L 5 S 1\_ Y} \vert < \vert {max\_Sag}_{L 5 S 2\_ X} - {max\_Sag}_{L 5 S 2\_ Y} \vert \qquad [ Equation 36 ]$$

Here, max_Sag_{L5S2_X} is a maximum sag value in the X direction of the image-side surface 154 of the fifth lens 150, and max_Sag_{L5S2_Y} is a maximum sag value in the Y direction of the image-side surface 154 of the fifth lens 150.

Accordingly, the distortion of light passing through the fifth lens 150 may be minimized, and light passing through the fifth lens 150 may be uniformly dispersed. Accordingly, since an effect in that a plurality of lenses are disposed in an overlapping manner using a single lens may be acquired, optical performance may be increased while implementing the optical system 100 in a small size.

$$10 < \vert {max\_Sag}_{L 5 S 2\_ X} - {max\_Sag}_{L 5 S 2\_ Y} \vert \text{} / \vert {max\_Sag}_{L 5 S 1\_ X} - {max\_Sag}_{L 5 S 1\_ Y} \vert \qquad [ Equation 37 ]$$

Accordingly, the distortion of light passing through the fifth lens 150 may be minimized, and light passing through the fifth lens 150 may be uniformly dispersed. Accordingly, since an effect in that a plurality of lenses are disposed in an overlapping manner using a single lens may be acquired, optical performance may be increased while implementing the optical system 100 in a small size.

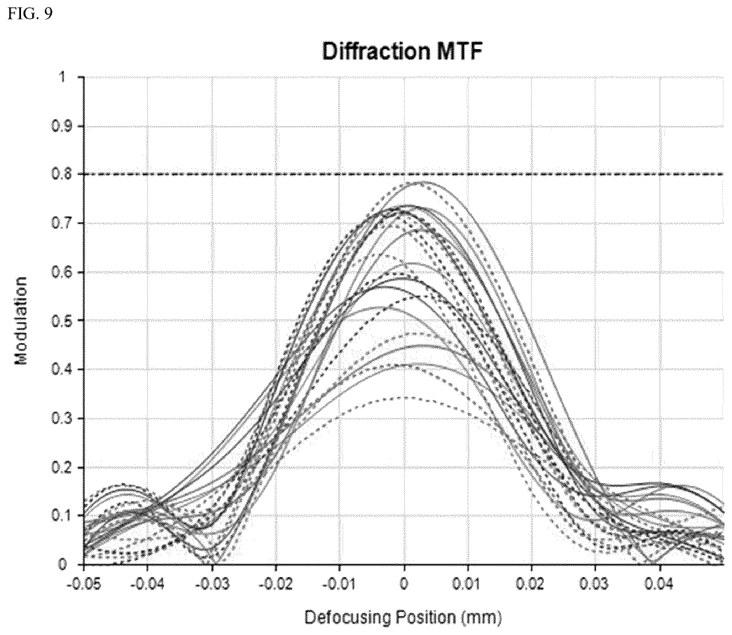

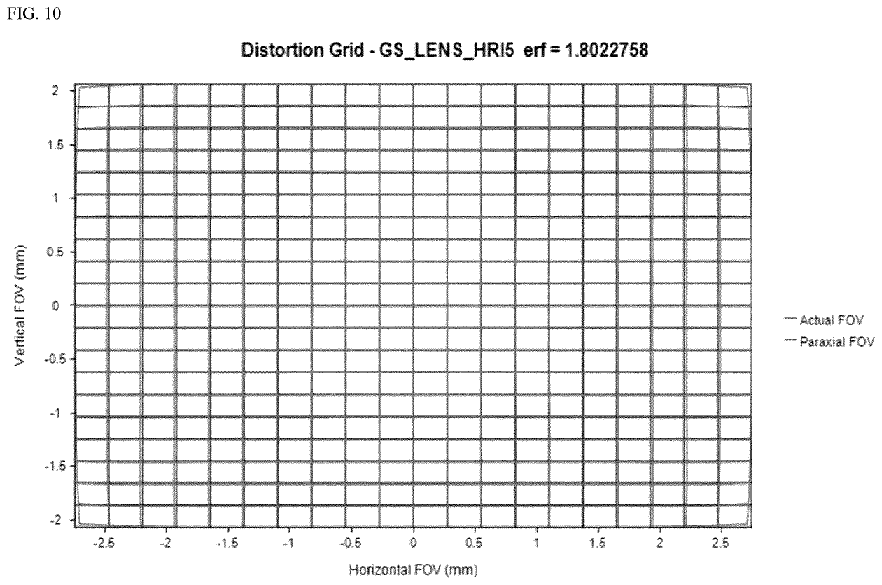

Table 5 shows chief ray angle (CRA) data and RI values which may be acquired using the optical system according to the embodiment of the present invention, by field, FIG. 9 shows a modulation transfer function (MTF) using the optical system according to one embodiment of the present invention, and FIG. 10 shows a distortion grid using the optical system according one embodiment of the present invention.

TABLE 5

| Field | CRA | RI(%) |
|---|---|---|
| 0 | 0 | 100.0% |
| 0.1 | 8.07145 | 99.1% |
| 0.2 | 15.5753 | 95.0% |
| 0.3 | 22.0528 | 87.3% |
| 0.4 | 27.1254 | 78.9% |
| 0.5 | 30.7006 | 70.8% |
| 0.6 | 33.1788 | 62.2% |
| 0.7 | 35.0345 | 53.7% |
| 0.8 | 36.3318 | 47.0% |
| 0.9 | 36.6351 | 43.3% |
| 1 | 35.5571 | 40.7% |

Referring to Table 5, in the optical system according to the embodiment of the present invention, it can be seen that an amount of light at the periphery of the image sensor (1 field) excluding the 0 field is 40% or more when a chief ray angle (CRA) is 8 degrees or more, for example, in a range of 8 degrees to 37 degrees, and an amount of light at a central portion of the image sensor (0 field) is 100%. Referring to FIG. 9, the sharpness of an image in a spatial frequency according to a pixel which may be acquired from the optical system according to one embodiment of the present invention may be acquired, and referring to FIG. 10, the degree of distortion of the image which may be acquired from the optical system according to one embodiment of the present invention may be acquired.

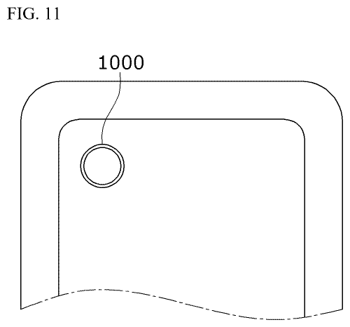

FIG. 11 is a view showing a portion of a mobile terminal to which a camera device according to one embodiment of the present invention is applied.

Meanwhile, the optical system 100 according to the embodiment of the present invention may be applied to a camera device 1000. The camera device 1000 including the optical system 100 according to the embodiment of the present invention may be built in a mobile terminal and applied along with a main camera module. The camera device 1000 according to the embodiment of the present invention may include an image sensor, a filter disposed on the image sensor, and an optical system 100 disposed on the filter, and the optical system 100 according to the embodiment of the present invention may include the above-described first lens 110, second lens 120, third lens 130, fourth lens 140, and fifth lens 150. The mobile terminal with a built-in camera device including the optical system according to the embodiment of the present invention may be a smartphone, a tablet personal computer (PC), a laptop computer, a personal digital assistant (PDA), or the like.

The optical system 100 according to the embodiment of the present invention may be sequentially disposed in a lateral direction of the mobile terminal due to a thickness constraint of the mobile terminal. To this end, as described above, a right-angled prism may be further disposed on a front end of the first lens 110.

The mobile terminal may be a smartphone, a tablet PC, a laptop computer, a PDA, or the like.

Although the embodiments have been mainly described above, these are merely examples and are not intended to limit the present invention, and it can be seen that various modifications and applications not exemplified herein are possible without departing from the essential characteristics of the present invention by those skilled in the art. For example, each of the components specifically shown in the embodiments may be modified and implemented. Further, it should be interpreted that differences related to the modifications and the applications are included in the scope of the present invention defined by the appended claims.

### REFERENCE NUMERALS

100: optical system
110: first lens
120: second lens
130: third lens
140: fourth lens
150: fifth lens

1. An optical system comprising an aperture, a first lens, a second lens, a third lens, a fourth lens, and a fifth lens, which are sequentially disposed from an object side to an image side,
wherein the first lens has positive refractive power, the second lens has negative refractive power, the third lens has positive refractive power, the fourth lens has positive refractive power, and the fifth lens has negative refractive power, and
both an object-side surface and an image-side surface of the fifth lens have a circular asymmetric shape.

2. The optical system of claim 1, wherein, when the aperture is closed, the shortest distance between the aperture and an object-side surface of the first lens is 0.2 mm or less.

3. The optical system of claim 1, wherein:
a distance between an image-side surface of the first lens and an object-side surface of the second lens and a distance between an image-side surface of the second lens and an object-side surface of the third lens are each shorter than a distance between an image-side surface of the third lens and an object-side surface of the fourth lens; and
a maximum effective diameter of an object-side surface and the image-side surface of the first lens, the object-side surface and the image-side surface of the second lens, and the object-side surface and the image-side surface of the third lens is smaller than a minimum effective diameter of the object-side surface and an image-side surface of the fourth lens and the object-side surface and the image-side surface of the fifth lens.

4. The optical system of claim 3, wherein the first lens, the second lens, the third lens, and the fourth lens are circular symmetrical lenses.

5. The optical system of claim 3, wherein at least one surface of the object-side surface and the image-side surface of the first lens, the object-side surface and the image-side surface of the second lens, and the object-side surface and the image-side surface of the third lens includes a critical point whose tilt angle is 0.

6. The optical system of claim 5, wherein:
at least two surfaces of the object-side surface of the fourth lens, the image-side surface of the fourth lens, and the object-side surface of the fifth lens do not include the critical point;
the object-side surface of the fourth lens is concave toward the object side;
the image-side surface of the fourth lens is convex toward the image side; and
the object-side surface of the fifth lens is concave toward the object side.

7. The optical system of claim 3, wherein:
a sag value in a first direction and a sag value in a second direction perpendicular to the first direction of the object-side surface of the fifth lens are different from each other for the same distance from an optical axis; and
a sag value in the first direction and a sag value in the second direction of the image-side surface of the fifth lens are different from each other for the same distance from the optical axis.

8. The optical system of claim 7, wherein the sag value in the first direction or the sag value in the second direction of the object-side surface of the fifth lens and a sag value in a third direction between the first direction and the second direction are different from each other for the same distance from the optical axis.

9. The optical system of claim 7, wherein a deviation between the sag value in the first direction and the sag value in the second direction of the image-side surface of the fifth lens is greater than a deviation between the sag value in the first direction and the sag value in the second direction of the object-side surface of the fifth lens for the same distance from the optical axis.

10. The optical system of claim 1, wherein an F-number is 2.45 or less, a field of view (FOV) is 80 degrees or more, and a relative illumination (RI) is 40% or more.

11. The optical system of claim 3, wherein the maximum effective diameter of the object-side surface and the image-side surface of the first lens, the object-side surface and the image-side surface of the second lens, and the object-side surface and the image-side surface of the third lens is 0.7 times or less an effective diameter of the image-side surface of the fifth lens.

12. The optical system of claim 6, wherein an absolute value of a radius of curvature of the image-side surface of the fourth lens is 0.9 to 1.1 times an absolute value of a radius of curvature of the object-side surface of the fifth lens.

13. The optical system of claim 8, wherein a deviation between the sag value in the first direction or the sag value in the second direction and the sag value in the third direction of the object-side surface of the fifth lens is greater than a deviation between the sag value in the first direction and the sag value in the second direction of the object-side surface of the fifth lens for the same distance from the optical axis.

14. The optical system of claim 9, wherein a deviation between a maximum sag value in the first direction and a maximum sag value in the second direction of the image-side surface of the fifth lens is 10 times or more a deviation between the maximum sag value in the first direction and the maximum sag value in the second direction of the object-side surface of the fifth lens.

15. The optical system of claim 9, wherein the image-side surface of the fifth lens includes a critical point whose tilt angle is 0.

16. The optical system of claim 15, wherein a maximum tilt angle from the critical point of the image-side surface of the fifth lens to an edge of the image-side surface of the fifth lens is 5 to 7 times a maximum tilt angle from the optical axis to the critical point of the image-side surface of the fifth lens.

17. The optical system of claim 15, wherein a maximum tilt angle is 65 degrees or less within a range of 60 to 90% of the effective diameter of the image-side surface of the fifth lens.

18. A camera device comprising:
an image sensor,
a filter disposed on the image sensor, and
an optical system disposed on the filter,
wherein the optical system includes an aperture, a first lens, a second lens, a third lens, a fourth lens, and a fifth lens, which are sequentially disposed from an object side to an image side, wherein the first lens has positive refractive power, the second lens has negative refractive power, the third lens has positive refractive power, the fourth lens has positive refractive power, and the fifth lens has negative refractive power, and
both an object-side surface and an image-side surface of the fifth lens have a circular asymmetric shape.

19. The camera device of claim 18, wherein, when the aperture is closed, the shortest distance between the aperture and an object-side surface of the first lens is 0.2 mm or less.

20. The camera device of claim 18, wherein:
a distance between an image-side surface of the first lens and an object-side surface of the second lens and a distance between an image-side surface of the second lens and an object-side surface of the third lens are each shorter than a distance between an image-side surface of the third lens and an object-side surface of the fourth lens; and
a maximum effective diameter of an object-side surface and the image-side surface of the first lens, the object-side surface and the image-side surface of the second lens, and the object-side surface and the image-side surface of the third lens is smaller than a minimum effective diameter of the object-side surface and an image-side surface of the fourth lens and the object-side surface and the image-side surface of the fifth lens.
